(19) United States
(12) Patent Application Publication
(10) Pub. No.: US 2020/0082321 A1
(43) Pub. Date: Mar. 12, 2020

(54) ADJUSTING OBJECT PLACEMENT WITHIN A PHYSICAL SPACE

(71) Applicant: International Business Machines Corporation, Armonk, NY (US)

(72) Inventors: Silvia Cristina Santa Ana Velasco, Zapopan (MX); Perla Guadalupe Reyes Ramírez, Jalisco (MX); Rogelio Rivera Gutierrez, Tequila (MX); Carolina Garcia Delgado, Zapopan (MX); Adam B. Childers, Tucson, AZ (US); Pamela Lembke, West Lafayette, IN (US); Richard B. Finch, New Paltz, NY (US)

(21) Appl. No.: 16/124,833

(22) Filed: Sep. 7, 2018

(51) Int. Cl. G06Q 10/06; G06Q 30/06

(52) U.S. Cl. CPC G06Q 10/063118; G06Q 10/06312; G06Q 30/0639

(57) ABSTRACT

In one example implementation according to aspects of the present disclosure, a computer-implemented method includes receiving, from a plurality of sensors, user data for a plurality of users, the plurality of sensors being distributed throughout a physical space. The method further includes analyzing the user data for the plurality of users. The method further includes generating an object placement plan based at least in part on a result of analyzing the user data, the object placement plan defining a location for each of a plurality of objects throughout the physical space. The method further includes collecting additional user data subsequent to implementing the object placement plan. The method further includes analyzing the additional user data. The method further includes generating an adjusted object placement plan based at least in part on a result of analyzing the additional user data.

### BACKGROUND

The present invention generally relates to object placement, and more specifically, to adjusting object placement within a physical space.

Objects can be placed within a physical space to be accessed by users within the physical space. For example, when a shopper goes to a supermarket to purchase groceries, the user travels throughout the supermarket collecting desired items and purchases them. In another example, a warehouse employee travels throughout a warehouse and collects desired items, such as to ship them to a customer, etc.

### SUMMARY

Embodiments of the present invention are directed to a computer-implemented method for adjusting object placement within a physical space. A non-limiting example of the computer-implemented method includes receiving, by a processing device and from a plurality of sensors, user data for a plurality of users, the plurality of sensors being distributed throughout a physical space. The method further includes analyzing, by the processing device, the user data for the plurality of users. The method further includes generating, by the processing device, an object placement plan based at least in part on a result of analyzing the user data, the object placement plan defining a location for each of a plurality of objects throughout the physical space. The method further includes collecting, by the processing device, additional user data subsequent to implementing the object placement plan. The method further includes analyzing, by the processing device, the additional user data. The method further includes generating, by the processing device, an adjusted object placement plan based at least in part on a result of analyzing the additional user data.

Embodiments of the present invention are directed to a system. A non-limiting example of the system includes a memory comprising computer readable instructions and a processing device for executing the computer readable instructions for performing a method for adjusting object placement within a physical space.

Embodiments of the invention are directed to a computer program product. A non-limiting example of the computer program product includes a computer readable storage medium having program instructions embodied therewith. The program instructions are executable by a processor to cause the processor to perform a method for adjusting object placement within a physical space.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to aspects of the present disclosure;

FIG. 2 depicts abstraction model layers according to aspects of the present disclosure;

FIG. 3 depicts a block diagram of a processing system for implementing the techniques described herein according to aspects of the present disclosure;

FIG. 4 depicts a block diagram of a processing system for adjusting object placement within a physical space according to one or more embodiments described herein;

FIG. 5 depicts a method for generating an object placement plan for placing objects within a physical space according to one or more embodiments described herein; and

FIG. 6 depicts a method for generating an object placement plan for placing objects within a physical space according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

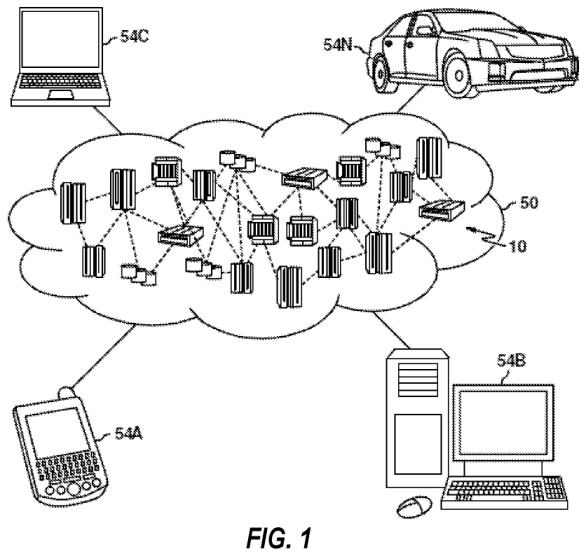

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

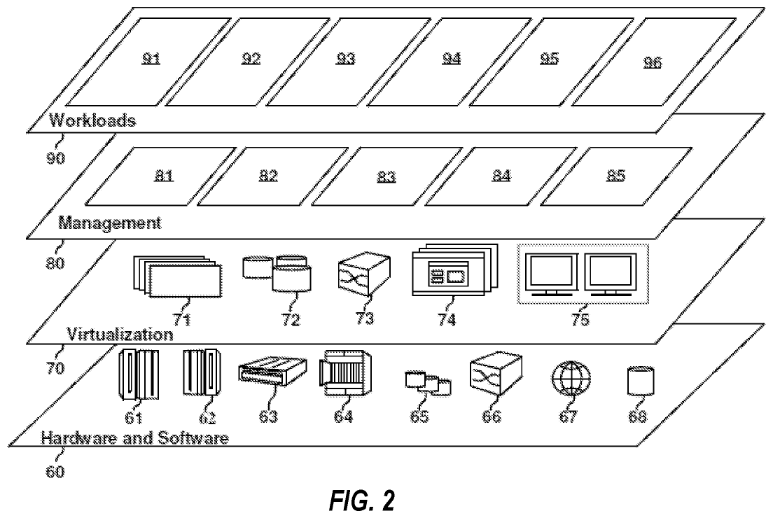

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and adjusting object placement in a physical space 96.

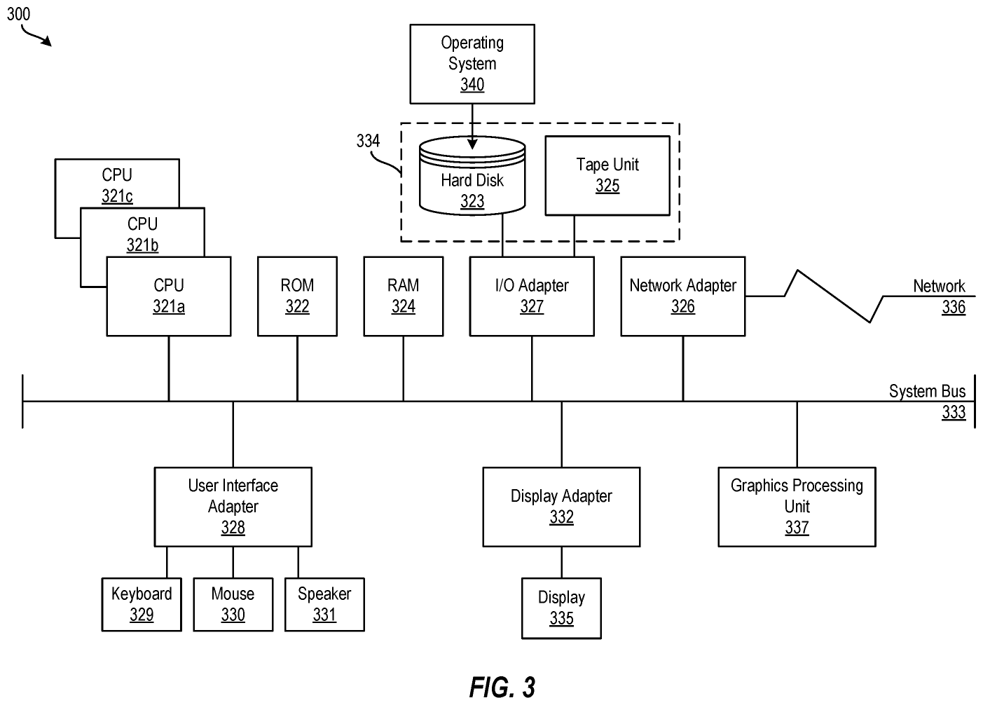

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adaptor 332, which may include a graphics adapter to improve the performance of graphics intensive applications and a video controller. In one aspect of the present disclosure, adapters 326, 327, and/or 232 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

Turning now to an overview of technologies that are more specifically relevant to aspects of the invention, technical solutions are provided that create object placement plans and staffing plans based on results of analyzing user data. For example, a retail store or supermarket may desire to place products within a physical location such that the products are easily accessible to users. However, certain areas within a physical location may be more frequently visited by users based on time of day, time of year, holidays, local events, weather, and the like. It is desirable to consider these factors when making product placement and staffing decisions such that a retail store or supermarket can improve user experience by placing products in appropriate locations for the users and having a suitable number of staff available to assist the users.

Existing approaches to object placement and staffing fail to adjust object placement based on locations in which users travel most frequently, fail to adjust product placement of low sales objects in areas of higher sales based on user behavior, fail to adjust staffing based on dynamic flow of users over time and in real-time, and fail to adjust inventory based on times of year, events, times that users purchase various items more or less often, and the like.

Turning now to an overview of the aspects of the invention, one or more embodiments of the invention address the above-described shortcomings of the prior art by providing historical and real-time data about users within a physical location. Using this data, the technical solutions provided herein can generate object placement plans and/or staffing plans. These object placement plans and staffing plans represent improvements over the art by considering information about how users interact in a physical space and adjusting objects/staffing based on this data, which can include both historical data and real-time data. These plans can improve user experiences, increase product availability through more accurate restocking, reduce wasted resources, etc.

The above-described aspects of the invention address the shortcomings of the prior art. In particular, the present techniques represent an improvement over prior art techniques by adjusting object placement based on locations in which users travel most frequently, by adjusting product placement of low sales objects in areas of higher sales based on user behavior, by adjusting staffing based on dynamic flow of users over time and in real-time, and by adjusting inventory based on times of year, events, times that users purchase various items more or less often, and the like. These and other improvements are described in more detail herein.

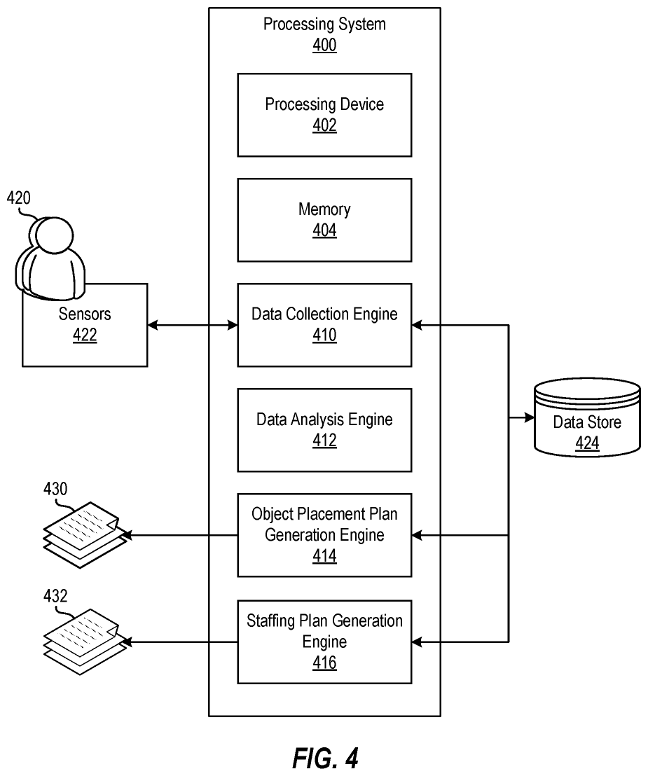

Turning now to a more detailed description of aspects of the present invention, FIG. 4 depicts a block diagram of a processing system 400 for adjusting object placement within a physical space according to one or more embodiments described herein. The processing system 400 can include a processing device 402, a memory 404, a data collection engine 410, a data analysis engine 412, an object placement plan generation engine 414, and a staffing plan generation engine 416.

The data collection engine 410 collects data from sensors 422 about users 420. The sensors 422 can be of any suitable type to observe and collect data about the users 420 within a physical space. According to one or more embodiments described herein, the sensors 422 can include cameras, motion sensors, fire/gas detection sensors, and the like positioned throughout the physical space. The sensors 422 can also include devices associated with the users 420, such as smartphones, tablet computers, wearable computing device, and the like, and any sensors associated therewith, such as cameras, gyroscopes, accelerometers, etc.

The data analysis engine 412 analyses data collected by the sensors 422 to determine the habits and behaviors of the users. For example, the data analysis engine 412 can analyze the collected data to determine a user's route through a supermarket, what products the user purchased, how long the user spent in different departments within the supermarket (e.g., produce, meat, frozen, etc.). This data analysis can be used in various ways. For example, the data analysis can be used to make staffing decisions/plans, to make product placement decisions/plans, to provide feedback to the supermarket or advertisers about customer habits and behavior, to drive customers to certain locations within the supermarket, to drive customers towards higher margin products, clearance products, expiring products, and the like.

The data analysis engine 412 can use the collected data to track users through the physical space, to track purchase history of the users, to create heat maps of user movement throughout the physical space, to track checkout/register data, and the like. For example, heat maps can be generated based on user movement throughout the physical space to determine “hot spots” that may be ideal for placement of promotional or new products to increase exposure to these items. The heat maps can also be used to make staffing decisions. For example, if users are determined to be waiting for extended periods near the deli, a staffing determination may be made to schedule (or hire) additional deli employees during certain times. According to one or more embodiments described herein, the data analysis engine 412 can determine which products that users purchase and when.

The object placement plan generation engine 414 uses the results of the data analysis to generate an object placement plan 430. The object placement plan 430 defines where objects (i.e., products) should be placed within the physical space. As described herein, the data analysis engine 412 can determine which products that users purchase and when. For example, the data analysis engine 412 may determine that users purchase cookout products (e.g., hot dogs, ice, beer, potato chips, etc.) on Saturdays during the summer. This data can be used by the object placement plan generation engine 414 to determine where these products should be placed to provide for an optimal user experience, exposure of the user to other products that may be of interest (e.g., place coolers near the beer, place hot dog buns near the hotdogs, etc.), maximum revenues to the supermarket, etc. The object placement plan 430 can also be useful for defining when and where to restock items for inventory and ordering purposes.

The staffing plan generation engine 416 uses the results of the data analysis to generate a staffing plan 432. The staffing plan 432 defines a number of a plurality of staff and a location for each of the plurality of staff throughout the physical space. For example, the staffing plan 432 can define how many employees should be staffed at a supermarket at a specific time. For example, it may be determined by the data analysis engine 412 that peak hours for the meat and seafood departments are Friday afternoon. Accordingly, the staffing plan 432 can define that additional staff should be scheduled during this time. Additionally, the staffing plan 432 can provide guidance when hiring new employees. For example, it may be desirable to hire new employees with availability corresponding to peak demand times for a store.

According to one or more embodiments described herein, cameras (e.g., sensors 422) within a supermarket can collect data about which checkout (register) lanes are available, which are busy, which are delayed, etc. by viewing customer lines at each checkout lane. The staffing plan generation engine 416 can use this data to create or update the staffing plan 432 to open a new lane, alert a manager, to direct a user to a particular lane, and the like.

The processing system 400 can be communicatively coupled to a data store 424, which can be used to store data collected by the sensors 422, results of the data analysis, the object placement plan 430, the staffing plan 432, and other data as appropriate.

The various components, modules, engines, etc. described regarding FIG. 4 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 402 for executing those instructions. Thus a system memory (e.g., the memory 404) can store program instructions that when executed by the processing device 402 implement the engines described herein. Other engines can also be utilized to include other features and functionality described in other examples herein.

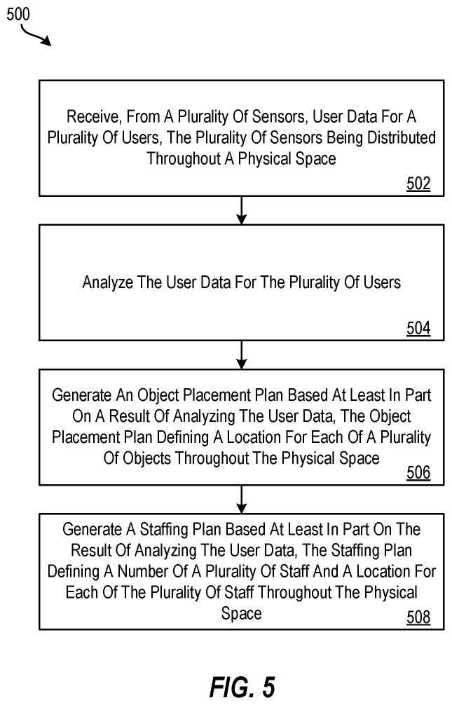

FIG. 5 depicts a method 500 for generating an object placement plan for placing objects within a physical space according to one or more embodiments described herein. The method 500 can be implemented using any suitable processing system (e.g., the cloud computing environment 50, the processing system 300, the processing system 400, etc.) and/or processing device (e.g., the processing device 321, the processing device 402, etc.).

At block 502, the data collection engine 410 receives (or acquires) user data for a plurality of users 420 using a plurality of sensors 422. The sensors 422 are distributed throughout a physical space, such as a retail store, warehouse, etc. The sensors 422 can include cameras, motion sensors, fire/gas detection sensors, and the like positioned throughout the physical space. The sensors 422 can also include devices associated with the users 420, such as smartphones, tablet computers, wearable computing device, and the like, and any sensors associated therewith, such as cameras, gyroscopes, accelerometers, etc.

At block 504, the data analysis engine 412 analyzes the user data for the plurality of users 420. For example, the data analysis engine 412 performs analysis on the user data to determine how a user interacts with objects in the physical space. For example, the data analysis engine 412 determines where users are in the physical space, for how long the users are in different locations within the physical space, what objects the users interact within the physical space, etc. In an example in which the physical space is a retail store or supermarket, the data analysis engine 412 can determine what products (i.e., objects) a user buys, what products a user inspects but does not buy, what brands of products a user buys, how long a user spends shopping, how the user moves throughout the store, and the like. According to one or more embodiments described herein, the user data can include GPS data received from a user device associated with a user. The data analysis engine 412 can determine where a user was in a physical space and for how long. This information is useful for determining where to place objects throughout the physical space.

At block 506, the object placement plan generation engine 414 generates an object placement plan 430 based at least in part on a result of analyzing the user data. The object placement plan 430 defines a location for each of a plurality of objects throughout the physical space. According to one or more embodiments described herein, the object placement plan 430 defines where to place grocery items and other foodstuffs in a grocery store. According to yet one or more additional embodiments described herein, the object placement plan 430 defines where to place goods in a warehouse. Subsequent to generating the object placement plan 430, the object placement plan 430 can be implemented. For example, the object placement plan generation engine 414 can dispatch employees and/or autonomous robots to place an object in or move an object to a specific location according to the object placement plan and/or an adjusted object placement plan. As one such example relating to a supermarket, an autonomous robot can be dispatched to move tailgating supplies (e.g., coolers, ice, hotdog buns, charcoal, etc.) to an area near the front of the supermarket on Friday evenings during football season. The autonomous robot can then be dispatched to move those same tailgating supplies to other areas (e.g., their normal areas) on Sunday evening. In this way, tailgating supplies can be conveniently located for customers during peak tailgating hours. This same area can be used for other products during the week, such as sale items, clearance items, etc.

At block 508, the staffing plan generation engine 416 generates a staffing plan 432 based at least in part on the result of analyzing the user data. The staffing plan 432 defines a number of a plurality of staff and a location for each of the plurality of staff throughout the physical space. According to one or more embodiments described herein, the staffing plan 432 defines how many employees (e.g., cashiers, stockers, etc.) should be working in a grocery store at a given time and at what location they should be located (e.g., three cashiers on express lanes, five cashers on regular lanes, an extra produce stocker, etc.). According to yet one or more additional embodiments described herein, the staffing plan 432 defines how many employers (e.g., stockers, pickers, etc.) should be working in a warehouse at a given time and at what location they should be located. Subsequent to generating the staffing plan 432, the staffing plan 432 can be implemented. For example, the staffing plan generation engine 416 can cause a scheduling program (not pictured) to automatically schedule staff based on the staffing plan 432.

Additional processes also may be included, and it should be understood that the process depicted in FIG. 5 represents an illustration, and that other processes may be added or existing processes may be removed, modified, or rearranged without departing from the scope and spirit of the present disclosure.

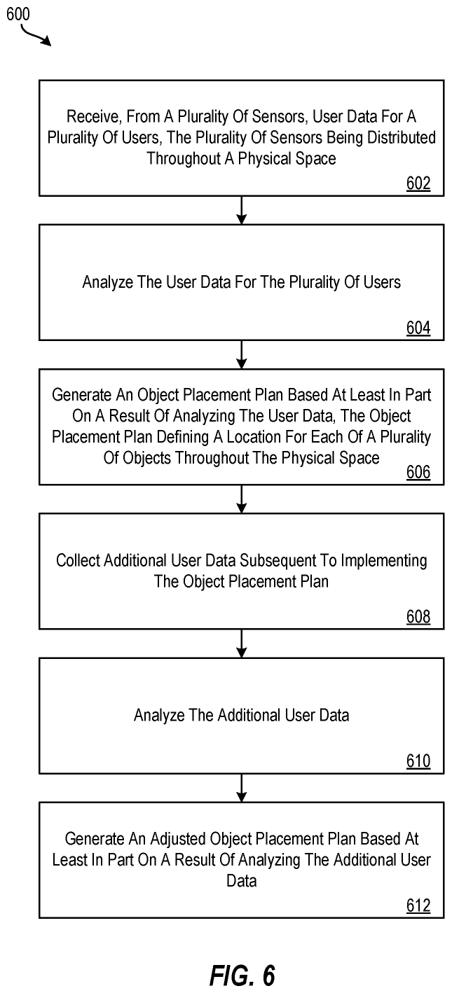

FIG. 6 depicts a method 600 for generating an object placement plan for placing objects within a physical space according to one or more embodiments described herein. The method 600 can be implemented using any suitable processing system (e.g., the cloud computing environment 50, the processing system 300, the processing system 400, etc.) and/or processing device (e.g., the processing device 321, the processing device 402, etc.).

At block 602, the data collection engine 410 receives, from a plurality of sensors (e.g., the sensors 422), user data for a plurality of users (e.g., the users 420). The sensors are distributed throughout a physical space. At block 604, the data analysis engine 412 analyzes the user data for the plurality of users. At block 606, the object placement plan generation engine 414 generates an object placement plan based at least in part on a result of analyzing the user data. The object placement plan defines a location for each of a plurality of objects throughout the physical space.

At block 608, the data collection engine 410 collects additional user data subsequent to implementing the object placement plan. At block 610, the data analysis engine 412 analyzes the additional user data. At block 612, the object placement plan generation engine generates an adjusted object placement plan based at least in part on a result of analyzing the additional user data.

By collecting, and analyzing additional user data subsequent to implement the object placement plan, the object placement plan can be revised/updated to reflect how users interact with objects in the physical space after the object placement plan is implemented. That is, data can be acquired based on the results of implementing the object placement plan. For example, in the case of a retail store, the additional data can be used to determine whether the object placement plan placed objects in areas of the physical space that lead to additional exposure of an object, additional sales of the object, etc. This improves the object placement plan by using additional data to further refine/adjust the object placement plan. This additional collection and analysis can also be used to generate the staffing plan by the staffing plan generation engine 416.

Additional processes also may be included, and it should be understood that the process depicted in FIG. 6 represents an illustration and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processing device and from a plurality of sensors, user data for a plurality of users, the plurality of sensors being distributed throughout a physical space;
analyzing, by the processing device, the user data for the plurality of users;
generating, by the processing device, an object placement plan based at least in part on a result of analyzing the user data, the object placement plan defining a location for each of a plurality of objects throughout the physical space;
collecting, by the processing device, additional user data subsequent to implementing the object placement plan;
analyzing, by the processing device, the additional user data; and
generating, by the processing device, an adjusted object placement plan based at least in part on a result of analyzing the additional user data.

2. The computer-implemented method of claim 1, further comprising:
receiving the user data from a user device associated with at least one of the plurality of users.

3. The computer-implemented method of claim 1, further comprising:
subsequent to generating the object placement plan, implementing the object placement plan.

4. The computer-implemented method of claim 1, further comprising:
subsequent to generating the adjusted object placement plan, implementing the adjusted object placement plan, wherein implementing the adjusted object placement plan comprises dispatching an autonomous robot to place one of the plurality of objects in or move one of the plurality of objects to a specific location in the physical space according to the adjusted object placement plan.

5. The computer-implemented method of claim 1, further comprising:
generating, by the processing device, a staffing plan based at least in part on the result of analyzing the user data, the staffing plan defining a number of a plurality of staff and a location for each of the plurality of staff throughout the physical space; and
subsequent to generating the staffing plan, implementing the staffing plan.

6. The computer-implemented method of claim 5, further comprising:
generating, by the processing device, an adjusted staffing plan based at least in part on the result of analyzing the additional user data.

7. The computer-implemented method of claim 1, wherein the physical space is a supermarket, wherein the objects are products for sale within the supermarket, and wherein the user data and the additional user data represent how the plurality of users move throughout the supermarket, how long the plurality of users spend in the supermarket, and which products the plurality of users buy from the supermarket.

8. A system comprising:
a memory comprising computer readable instructions; and
a processing device for executing the computer readable instructions for performing a method comprising:
receiving, by the processing device and from a plurality of sensors, user data for a plurality of users, the plurality of sensors being distributed throughout a physical space;
analyzing, by the processing device, the user data for the plurality of users;
generating, by the processing device, an object placement plan based at least in part on a result of analyzing the user data, the object placement plan defining a location for each of a plurality of objects throughout the physical space;
collecting, by the processing device, additional user data subsequent to implementing the object placement plan;
analyzing, by the processing device, the additional user data; and
generating, by the processing device, an adjusted object placement plan based at least in part on a result of analyzing the additional user data.

9. The system of claim 8, wherein the method further comprises:
receiving the user data from a user device associated with at least one of the plurality of users.

10. The system of claim 8, wherein the method further comprises:
subsequent to generating the object placement plan, implementing the object placement plan.

11. The system of claim 8, wherein the method further comprises:
subsequent to generating the adjusted object placement plan, implementing the adjusted object placement plan.

12. The system of claim 8, wherein the method further comprises:
generating, by the processing device, a staffing plan based at least in part on the result of analyzing the user data, the staffing plan defining a number of a plurality of staff and a location for each of the plurality of staff throughout the physical space; and
subsequent to generating the staffing plan, implementing the staffing plan.

13. The system of claim 12, wherein the method further comprises:
generating, by the processing device, an adjusted staffing plan based at least in part on the result of analyzing the additional user data.

14. The system of claim 8, wherein the physical space is a supermarket, wherein the objects are products for sale within the supermarket, and wherein the user data and the additional user data represent how the plurality of users move throughout the supermarket, how long the plurality of users spend in the supermarket, and which products the plurality of users buy from the supermarket.

15. A computer program product comprising:
a computer readable storage medium having program instructions embodied therewith, the program instructions executable by a processing device to cause the processing device to perform a method comprising:
receiving, by the processing device and from a plurality of sensors, user data for a plurality of users, the plurality of sensors being distributed throughout a physical space;
analyzing, by the processing device, the user data for the plurality of users;
generating, by the processing device, an object placement plan based at least in part on a result of analyzing the user data, the object placement plan defining a location for each of a plurality of objects throughout the physical space;
collecting, by the processing device, additional user data subsequent to implementing the object placement plan;
analyzing, by the processing device, the additional user data; and
generating, by the processing device, an adjusted object placement plan based at least in part on a result of analyzing the additional user data.

16. The computer program product of claim 15, wherein the method further comprises:
receiving the user data from a user device associated with at least one of the plurality of users.

17. The computer program product of claim 15, wherein the method further comprises:
subsequent to generating the object placement plan, implementing the object placement plan.

18. The computer program product of claim 15, wherein the method further comprises:
subsequent to generating the adjusted object placement plan, implementing the adjusted object placement plan.

19. The computer program product of claim 15, wherein the method further comprises:
generating, by the processing device, a staffing plan based at least in part on the result of analyzing the user data, the staffing plan defining a number of a plurality of staff and a location for each of the plurality of staff throughout the physical space;
subsequent to generating the staffing plan, implementing the staffing plan; and
generating, by the processing device, an adjusted staffing plan based at least in part on the result of analyzing the additional user data.

20. The computer program product of claim 15, wherein the physical space is a supermarket, wherein the objects are products for sale within the supermarket, and wherein the user data and the additional user data represent how the plurality of users move throughout the supermarket, how long the plurality of users spend in the supermarket, and which products the plurality of users buy from the supermarket.
